(19) United States
(12) Patent Application Publication
(10) Pub. No.: US 2016/0250841 A1
(43) Pub. Date: Sep. 1, 2016

(54) METHOD FOR IMPROVING OPERATING CONDITIONS OF A PRINTING MACHINE, AND A PRINTING MACHINE

(71) Applicant: NEOPACK, S.L., Riudellots de la Selva (Girona) (ES)

(72) Inventors: Luis Antonio Ruiz Sueza, Barcelona (Barcelona) (ES); Juan Carlos Bonifacio Martínez, Llagostera (Girona) (ES); Adelbert Lucas Schoonman, Eeerbeek (NL); Miquel Marco Padrosa, Porqueres (Girona) (ES)

(73) Assignee: NEOPACK, S.L., Riudellots de la Selva (Girona) (ES)

(21) Appl. No.: 14/957,600

(22) Filed: Dec. 3, 2015

(30) Foreign Application Priority Data
Dec. 3, 2014 (EP) 14004071.8

(51) Int. Cl. B41F 3/54

(52) U.S. Cl. CPC B41F 3/54

(57) ABSTRACT

The printing machine comprises an impression cylinder (10) having a support surface (10a) supporting a web substrate (S), a pressure roller (12) pressing the web substrate (S) against the impression cylinder (10), one or more printing units (14) for printing ink on said web substrate (S) supported on the impression cylinder (10), and a liquid applying unit (18) for applying liquid insoluble with the ink being printed on the support surface (10a) of the impression cylinder (10) upstream of said pressure roller (12), said liquid forming a liquid layer (L) on at least one specific area of the support surface (10a) of the impression cylinder (10), so that the liquid layer (L) provides an ink-repellent coating on areas of the support surface (10a) not covered by the web substrate (S) and optionally an increased bonding of the web substrate (S) to the support surface (10a).

### TECHNICAL FIELD

The present invention concerns to a method for improving operating conditions of a printing machine by providing ink-repellent areas on a support surface of an impression cylinder of the printing machine supporting a web substrate, especially useful when the web substrate has a substrate width which is less than a maximum impression width of the support surface of the impression cylinder and lees than a printing width of a printing cylinder, and optionally by increasing bonding between the web substrate and the support surface of the impression cylinder.

The present invention also concerns to a printing machine including a device implementing the method.

### BACKGROUND ART

Printing machines comprising a rotary impression cylinder having a support surface which supports a web substrate moved in a transport direction, at least one pressure roller pressing said web substrate against said support surface of said impression cylinder, and at least one printing unit having at least one printing cylinder arranged for printing ink on said web substrate supported on the impression cylinder are well known.

Document U.S. Pat. No. 1,711,596 A discloses a printing machine having a first rotary impression cylinder supporting a paper web moved in a transport direction, a first pair of printing units arranged for printing ink on a first side of the paper web supported on the first impression cylinder, a second rotary impression cylinder supporting the paper web downstream the first impression cylinder with the freshly printed first side of the paper web toward the second impression cylinder, and a second pair of printing units arranged for printing ink on a second side of the paper web supported on the second impression cylinder. The second impression cylinder has a smooth absorbent non-metallic surface and the printing machine comprises means for supplying said smooth absorbent non-metallic surface with water to keep it moist and resistant to fresh ink in order to prevent offset at the freshly printed first side of the paper web.

The means for supplying a smooth absorbent non-metallic surface of an impression cylinder with water described in the cited document U.S. Pat. No. 1,711,596 A are unnecessary when applied to a printing machine configured for printing ink on a single side of a web substrate because in this case the side of the web substrate which is in contact with the impression cylinder is not printed or not freshly printed, and there is no risk of dirtying the impression cylinder with a freshly printed side of the web substrate in contact therewith.

Document DE 19921632 A discloses a printing machine having a printing unit including two opposite printing cylinders for printing both sides of a moving web, deflection rollers through which the freshly printed web is guided, and application devices including spraying nozzles which directly transfers a water solution onto the deflection rollers in order to prevent offset at the freshly printed sides of the web in contact with the deflection rollers. The deflection rollers have a hydrophilous surface which may consist of chrome. In this printing machine the deflection rollers have no risk of receiving ink from the printing cylinders because the deflection rollers do not make a nip with the printing cylinders.

A problem arises when the web substrate being printed in the printing machine has a substrate width which is less than a maximum impression width of the support surface of the impression cylinder and less than a printing width of the printing cylinder because ink printed by the printing cylinder can dirt and build-up on areas of the support surface of the impression cylinder not covered by the web substrate, making it necessary to often clean the dirtied areas of the support surface of the impression cylinder.

This problem gets worse in offset printing, wherein the surface of the printing cylinder, due to the compressible nature of the blanket coating thereof, is deformed during printing to a certain extent to accommodate the thickness of the web substrate so that the end portions of the printing cylinder are in contact with the non-covered areas of the impression cylinder applying ink thereon, and this effect is more pronounced the more thinner the thickness of the web substrate. In flexographic printing a similar effect occurs, for example, when printing full solid tone at full coverage.

None of the previously cited documents U.S. Pat. No. 1,711,596 A and DE 19921632 A addresses the mentioned problem of dirtying of the areas of the support surface of the impression cylinder not covered by the web substrate with the ink printed by the printing cylinder in printing machines configured for printing ink on a single side of a web substrate.

Document U.S. Pat. No. 5,913,471 A discloses a printing machine having a capture device for capturing a web substrate in the event of a tear in the web substrate including two capture cylinders the outer surfaces of which are made of an ink-repellent material, such as, for example, chrome, for preventing an ink build-up on the capture cylinders, optionally in cooperation with washing devices for removing the printing ink deposited on the outer surface of the capture cylinders. A drawback of this device is that a cylinder having an outer surface made of an ink-repellent material, such as, for example, chrome, is difficult and expensive to manufacture and does not completely prevent adhesion of ink such that additional washing devices may be necessary.

Another problem that sometimes occurs in the known printing machines is that the web substrate undesirably moves with respect to the support surface of the impression cylinder, or air bubbles are trapped between a back face of the web substrate and the support surface of the impression cylinder during a printing work, which can cause imperfections in the printing work. In addition, when the ink being used has a significant tack, the ink tends to lift the web substrate from the support surface of the impression cylinder when the printed front face of the web substrate is separated from the ink-applying surface of the printing cylinder.

Document EP 1318014 A discloses the use of electrostatic attraction between the web substrate and the support surface of the impression cylinder for creating a bonding effect that temporarily bonds the web substrate to the support surface of the impression cylinder during a printing work. Other similar devices based on the same principle are known from documents EP 2308680 A1 and DE 3935013.

A drawback with the electrostatic bonding is that it requires that the web substrate is made of a material capable of being electrostatically charged. Furthermore, the electrostatic bonding of the web substrate on the support surface of the impression cylinder does not prevent the presence of air bubbles trapped therebetween, and besides makes it difficult to use for example a pressure roller for quickly and easily removing bubbles and resituating portions of the web substrate which have initially improperly placed on the support surface of the impression cylinder producing wrinkles or bulges.

### DISCLOSURE OF THE INVENTION

According to a first aspect, the present invention affords a method for improving operating conditions of a printing machine, said printing machine being of a known type comprising a rotary impression cylinder having a support surface which supports a web substrate moved in a transport direction, at least one pressure roller pressing said web substrate against the support surface of the impression cylinder, said pressure roller providing an entry nip at which the web substrate first comes into contact with the support surface of the impression cylinder, and at least one printing unit having at least one printing cylinder arranged for printing ink on said web substrate supported on the impression cylinder.

The method of the present invention comprises applying a liquid insoluble with the ink being printed on the support surface of the impression cylinder upstream of the pressure roller, said liquid forming a liquid layer on one or more specific areas of the support surface of the impression cylinder, said liquid layer providing an ink-repellent coating on a non-covered area of the support surface of the impression cylinder that will be not covered by the web substrate during printing and that is adjacent to one side edge of the web substrate.

The support surface of the impression cylinder exhibits at least one non-covered area when the web substrate has a substrate width which is less than a maximum impression width of the support surface of the impression cylinder. If in addition the printing cylinder has a printing width which is wider than the substrate width, there is a risk that the ink being applied by the printing cylinder dirties and builds-up on this at least one non-covered area of the support surface of the impression cylinder during printing.

For example in offset printing, the surface of the printing cylinder includes a compressible blanket coating which is deformed during printing to a certain extent to accommodate the thickness of the web substrate so that the end portions of the printing cylinder are in contact with the non-covered areas of the impression cylinder applying ink thereon. In flexographic printing a similar effect occurs, for example, when printing full solid tone at full coverage.

The ink-repellent coating provided by the liquid layer on the non-covered area of the support surface of the impression cylinder prevents this non-covered area of the support surface of the impression cylinder from being dirtied by the printing cylinder during printing due to the nature insoluble with the ink of the liquid forming the liquid layer.

Usually, the support surface of the impression cylinder exhibits two non-covered areas that will be not covered by the web substrate during printing and that are respectively adjacent to opposite side edges of the web substrate, in which case, the liquid layer provides an ink-repellent coating on these two non-covered areas of the support surface of the impression cylinder.

Nevertheless, the support surface of the impression cylinder can exhibit a single non-covered area adjacent to one side edge of the web substrate, for example when the opposite side edge of the web substrate coincides with one end edge of the impression cylinder, or can exhibit more than two non-covered areas, for example when the web substrate is reversed an supported twice on the impression cylinder. In any case, the liquid layer preferably provides an ink-repellent coating on each non-covered area of the support surface of the impression cylinder that will be not covered by the web substrate during printing and that is adjacent to one side edge of the web substrate.

In another embodiment of the method, the liquid layer is further formed on at least one covered area of the support surface of the impression cylinder that will be covered by the web substrate during printing and that is adjacent to one side edge of the web substrate, so that the liquid layer provides an increased bonding between the web substrate and the at least one covered area of the support surface of the impression cylinder in addition to the ink-repellent coating on the at least one non-covered area of the support surface of the impression cylinder.

Preferably, the liquid layer is further formed on two covered areas of the support surface of the impression cylinder that will be covered by the web substrate during printing and that are adjacent to the two opposite side edges of the web substrate, respectively. More preferably, the liquid layer spans the complete substrate width comprised between the two opposite side edges of the web substrate.

This liquid layer between the web substrate and the covered area of the support surface of the impression cylinder, when pressed with the pressure roller at the entry nip, creates a liquid barrier that prevents air to be dragged by the web substrate and/or by the impression cylinder and remain between the web substrate and the support surface of the impression cylinder and avoids the presence of trapped air causing imperfections in the printing work. In addition, the liquid layer replaces air existing in possible pores or surface imperfections of the support surface of the impression cylinder by liquid and prevents air bubbles from being trapped between the web substrate and the support surface of the impression cylinder. The result is a more even and increased bonding of the web substrate to the covered area of the support surface of the impression cylinder provided by the liquid layer arranged therebetween.

Furthermore, the liquid layer between the web substrate and the covered area of the support surface of the impression cylinder enables or facilitates a re-location of portions of the web substrate having initially been improperly placed on the support surface of the impression cylinder by slipping the web substrate on the support surface of the impression cylinder in cooperation with the liquid layer under the action of the pressure roller.

In an embodiment, the support surface of the rotary impression cylinder is a smooth non-absorbent support surface provided, for example, by a corrosion resistant metallic material including stainless steel, or chrome, or an alloy comprising nickel and molybdenum, and the web substrate is made of a non-absorbent material, such as a plastic film, so that the liquid forming the liquid layer between the covered area of the support surface of the rotary impression cylinder and the web substrate is not absorbed enabling to provide a very thin liquid layer.

It is to be noted that the increase of bonding effect produced by the liquid layer on the one or more covered areas is independent from the ink repellent effect produced by the liquid layer on the one or more non-covered areas.

Therefore, in still another embodiment which does not belong to the method of the present invention but which can be carried out with the printing machine of the present invention, the liquid forms a liquid layer only on at least one covered area of the support surface of the impression cylinder that will be covered by the web substrate during printing for the only purpose of increasing bonding between the web substrate and the covered area of the support surface of the impression cylinder and/or enabling a re-location of portions of the web substrate having initially been improperly placed on the support surface of the impression cylinder. In this case, the liquid layer is preferably formed on two covered areas of the support surface of the impression cylinder that will be covered by the web substrate during printing and that are adjacent to the two opposite side edges of the web substrate, respectively, and more preferably the liquid layer spans the complete substrate width comprised between the two opposite side edges of the web substrate.

When the liquid layer is only used for increasing bonding and/or for enabling re-location of portions of the web substrate the liquid is not necessarily a liquid insoluble with the ink being printed.

The liquid is applied as the liquid layer on the support surface of the impression cylinder by means of a liquid applying unit. Preferably, the operation of said liquid applying unit is controlled by control means, such that a programmable logic controller, a computer, an electronic circuit or the like, enabling to adapt the flow rate and/or the distribution of the applied liquid to particular printing conditions, such as for example the particularities of the web substrate, the printing design, the kind of ink, the printing cylinder surface, the printing speed at which the web substrate is being printed, among other prevailing conditions.

A very thin liquid layer has proved to be enough to repel the ink. For example, an appropriate thickness for the liquid layer is in the range of 0.05 to 2 microns (millionths of a meter). When the ink being printed is a water-insoluble ink such as, for example, one of those used in offset printing, the liquid used to form the liquid layer is water or a liquid based on water.

It has also been proved that a similar thickness in the range of 0.05 to 2 microns is appropriate for the liquid layer located between the web substrate and the covered area of the support surface of the impression cylinder to provide, once pressed by the pressure roller, a bonding effect that temporarily bonds the web substrate to the support surface of the impression cylinder during printing.

According to a second aspect, the present invention provides a printing machine comprising a rotary impression cylinder having a support surface which supports a web substrate moved in a transport direction, at least one pressure roller pressing said web substrate against said support surface of said impression cylinder, said pressure roller providing an entry nip at which the web substrate first comes into contact with the support surface of the impression cylinder, and at least one printing unit having at least one printing cylinder arranged for printing ink on said web substrate supported on the impression cylinder.

The printing machine of the present invention further comprises a liquid applying unit which applies a liquid insoluble with the ink being printed on the support surface of the impression cylinder upstream of said pressure roller, said liquid forming a liquid layer on at least one specific area of the support surface of the impression cylinder.

By making use of the liquid applying unit, the printing machine according to the second aspect of the present invention implements the method for improving operating conditions of a printing machine, i.e. providing an ink-repellent coating on at least one non-covered area of the support surface of the impression cylinder and optionally an increased bonding of the web substrate to at least one covered area of the support surface of the impression cylinder, according to the first aspect of the present invention.

In one embodiment, the aforementioned liquid applying unit includes a plurality of spray nozzles and a set of transfer rollers comprising a receiving roller which receives a liquid sprayed from said spray nozzles and a laminating roller which laminates said liquid onto the support surface of the impression cylinder to form the liquid layer thereon. For example, said receiving roller is in rolling contact with said laminating roller, and the laminating roller is in rolling contact with the support surface of the impression cylinder.

The receiving roller and the laminating roller have preferably the same width, in a direction parallel to their own axes, than the maximum impression width of the support surface of the impression cylinder, and the spray nozzles are distributed along the length of the receiving roller so as to apply the liquid on the entire surface thereof.

Preferably, the printing machine further comprises control means, such that a programmable logic controller, a computer, an electronic circuit, or the like, that control the operation of said spray nozzles of the liquid applying unit for adapting the flow rate of the sprayed liquid to particularities of the web substrate and/or to a printing speed at which the web substrate is being printed and/or to other prevailing conditions. The control means preferably control the individual operation of each spray nozzle.

The liquid applying unit preferably comprises a plurality of electrically or electronically controllable valve devices arranged along an axial direction of the impression cylinder and associated with liquid supplying ducts connected to the spray nozzles, said valve devices being connected to and controlled by said control means to supply said liquid from a liquid supply to selected ones of the spray nozzles or to selected groups of spray nozzles at a selected flow rate. This permits to select the distribution, i.e. the specific one or more areas of the support surface of the impression cylinder on which the liquid layer is applied by the liquid applying unit, and/or the flow rate, i. e. amount of liquid that is sprayed by each spray nozzle per time unit. For example, electrically or electronically controllable valve devices include electric solenoid valves and electronic control valves.

In one embodiment, the impression cylinder of the printing machine is a central impression cylinder around which a plurality of said printing units are arranged for printing a plurality of inks on the web substrate supported on said central impression cylinder, wherein one pressure roller provides an entry nip in which the web substrate comes first in contact with the support surface of the impression cylinder upstream of the first printing unit, and wherein the liquid applying unit is located upstream of the entry nip.

In another embodiment, the printing machine comprises a plurality of said impression cylinders, for example arranged in line, to support the web substrate. In this case, at least one pressure roller is arranged to press the web substrate against a support surface of each impression cylinder to provide an entry nip for the web substrate, at least one printing unit is arranged for printing ink on said web substrate supported on each impression cylinder downstream the corresponding entry nip, and one liquid applying unit is arranged for applying the liquid layer on the support surface of each impression cylinder upstream of the respective pressure roller.

In both embodiments, at least one of the printing units is an offset printing unit. However, the printing units can alternatively or additionally include at least one flexographic printing unit or at least one rotogravure printing unit.

### BRIEF DESCRIPTION OF THE DRAWINGS

The foregoing and other advantages and features will be better understood from the following detailed description of illustrative and not limiting exemplary embodiments with reference to the accompanying drawings, in which:

FIG. 1 is a schematic front view of a printing machine according to an embodiment of the second aspect of the present invention implementing a method for improving operating conditions of a printing machine according to the first aspect of the present invention;

FIG. 2 is an enlarged detail of FIG. 1;

FIG. 3 is a schematic side view of elements of a liquid applying unit included in the printing machine;

FIGS. 4, 5 and 6 are partially sectioned side views of an impression cylinder and a printing cylinder of the printing machine of FIGS. 1 and 2 with a web substrate and a liquid layer arranged therebetween illustrating different embodiments of the method according to the first aspect of the present invention;

FIG. 7 is a partially sectioned side view of an impression cylinder and a printing cylinder of the printing machine of FIGS. 1 and 2 with a web substrate and a liquid layer arranged therebetween illustrating an alternative method embodiment which does belong to the present invention; and

FIG. 8 is a schematic front view of a printing machine according to another embodiment of the second aspect of the present invention implementing the method for improving operating conditions of a printing machine according to the first aspect of the present invention.

### DETAILED DESCRIPTION OF EXEMPLARY EMBODIMENTS

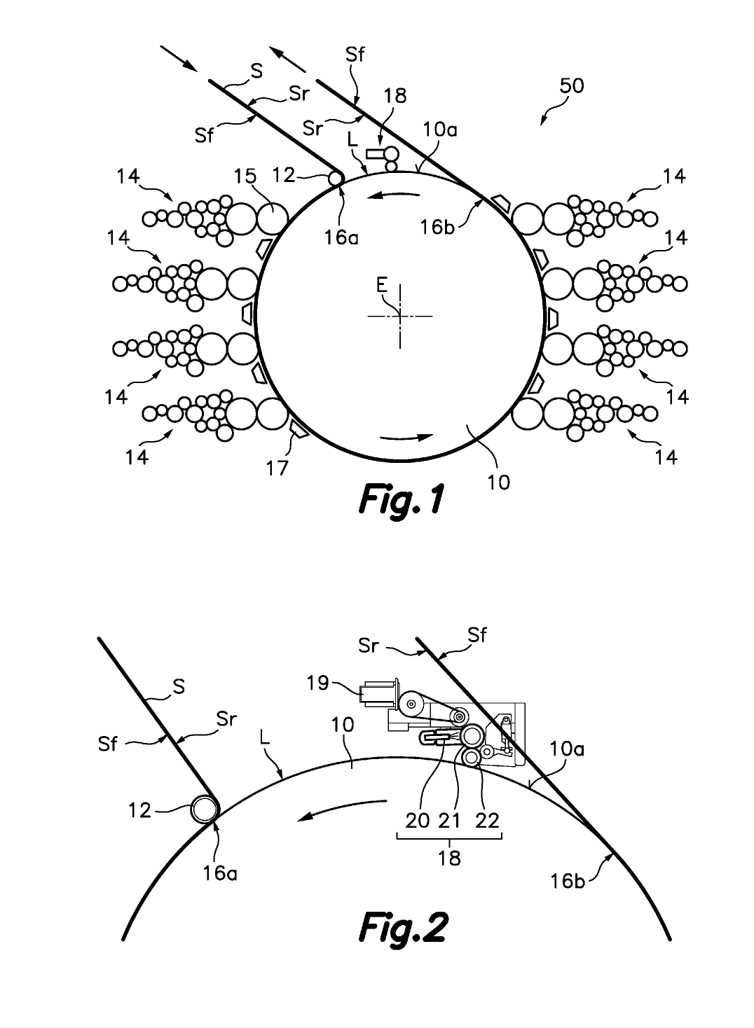

Referring first to FIGS. 1 and 2, reference sign 50 designates a printing machine according to an embodiment of the second aspect of the present invention. The printing machine 50 comprises a rotary impression cylinder 10, in particular a central impression cylinder 10 arranged to rotate about an axis E. The impression cylinder 10 has a support surface 10a that supports a web substrate S moved in a transport direction indicated by arrows. The web substrate S has a rear face Sr which during a printing work is in contact with said support surface 10a of the impression cylinder 10 and an opposite front face Sf which will receive printed inks.

The printing machine comprises guiding rollers which guide the web substrate S from an unwinding device (not shown) to the impression cylinder 10. These guiding rollers comprise a pressure roller 12 pressing the web substrate S against the support surface 10a of the impression cylinder 10 to provide an entry nip 16a in which the web substrate S initially comes into contact with the support surface 10a of the impression cylinder 10. The web substrate S leaves the support surface 10a of the impression cylinder 10 at a leaving line 16b. Thus, during operation, a portion of the support surface 10a of the impression cylinder 10 comprised between the leaving line 16b and the entry nip 16a remains uncovered by the web substrate S and fully exposed.

The support surface 10a of the rotary impression cylinder 10 is a smooth non-absorbent support surface provided, for example, by a corrosion resistant metallic material including stainless steel, or chrome, or an alloy comprising nickel and molybdenum. The web substrate S is made of a non-absorbent material, such as a plastic film.

Around the impression cylinder 10, and downstream of the entry nip 16a in the forward direction of the web substrate S, a plurality of printing units 14 are arranged. Each of said printing units 14 has a printing cylinder 15 which prints a corresponding ink on said front face Sf of the web substrate S supported on the support surface 10a of the impression cylinder 10. A drying/curing device 17 is arranged downstream of each printing unit 14 to dry/cure the ink printed by this printing unit 14 on the front face Sf of the web substrate S before the ink printed by the next printing unit 14 is printed on. Additionally or alternatively, an end drying/curing device (not shown) is arranged to dry/cure the inks printed by the printing units 14 on the front face Sf of the web substrate S all together downstream the leaving line 16b.

In FIGS. 1 and 2 the printing units 14 are depicted as being offset printing units. However, the printing units could alternatively be other types of printing units, such as flexographic printing units or rotogravure printing units, or a combination of one or more offset printing units and/or one or more flexographic printing units and/or one or more rotogravure printing units.

The printing machine 50 further comprises a liquid applying unit 18 arranged for applying a liquid insoluble with the ink being printed to form a liquid layer L on said fully exposed portion of the support surface 10a of the impression cylinder 10 located downstream of the leaving line 16b and upstream of said pressure roller 12 and therefore upstream of the entry nip 16a. Then, the pressure roller 12 presses the web substrate S against the liquid layer L applied on the support surface 10a of the impression cylinder 10 at the entry nip 16a.

Depending on the areas of the support surface 10a of the impression cylinder 10 which the liquid layer is applied on, the liquid layer L can be used to provide an ink-repellent coating on one or more non-covered areas NCA of the support surface 10a of the impression cylinder 10 and optionally to increase bonding of the web substrate S to one or more covered areas CA of the support surface 10a of the impression cylinder 10, as explained below with reference to FIGS. 4-7.

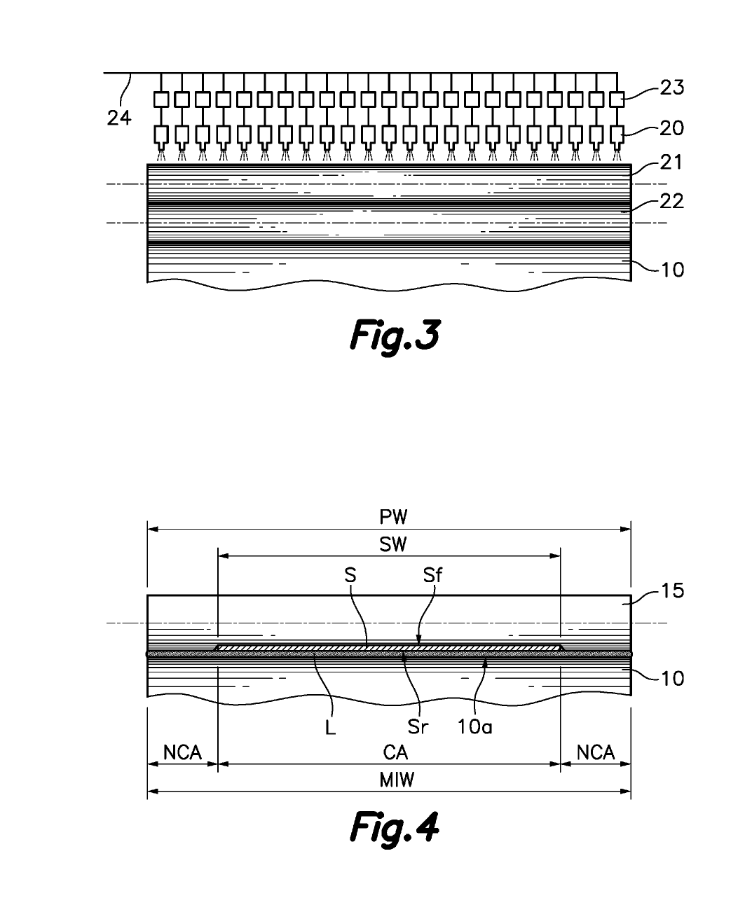

As shown in FIGS. 2 and 3, the liquid applying unit 18 includes a plurality of spray nozzles 20 and a set of parallel rotating rollers rotated by a motor 19. In the embodiment shown in FIGS. 2 and 3, the set of parallel rotating rollers comprises a receiving roller 21 and a rolling laminating roller 22. As better shown in FIG. 3, the spray nozzles 20 are connected to liquid supplying ducts 24 and arranged along the length of the receiving roller 21 so as to apply the liquid on the entire surface thereof. The receiving roller 21 is in rolling contact with the laminating roller 22, and the laminating roller 22 is in rolling contact with the support surface 10a of the impression cylinder 10. Thus, the receiving roller 21 transfers the liquid to the laminating roller 22 and the laminating roller 22 laminates the liquid as the liquid layer L onto the support surface 10a of the impression cylinder 10.

Preferably, the printing machine 50 includes control means, such that a programmable logic controller, a computer, an electronic circuit or the like, for controlling the liquid applying unit 18 so that the liquid applying unit 18 supplies the liquid at a controlled flow rate and distribution. For example, as schematically shown in FIG. 3, the liquid applying unit 18 comprises a plurality of electrically or electronically controllable valve devices 23 arranged along an axial direction with respect to the impression cylinder 10 and connected to the control means.

The valve devices 23 are associated with the liquid supplying ducts 24 which supply the liquid from a liquid supply (not shown) to the spray nozzles 20, and these valve devices 23 are controlled by said control means so that the liquid can be selectively supplied to one or more selected spray nozzles 20 or to one or more selected groups of the spray nozzles 20 to apply the liquid as the liquid layer L on selected areas of the support surface 10a of the impression cylinder 10. The valve devices 23 are additionally or alternatively controlled by the control means to regulate the flow rate of the liquid sprayed by each spray nozzle 20 or each group of spray nozzles 20.

When the inks being printed by the printing units 14 are water-insoluble inks, which is, for example, the case of the inks usually used in offset printing, the liquid used to form the liquid layer L is water or a liquid based on water. Preferably, the liquid layer L applied by the liquid applying unit 18 has a thickness in the range of 0.05 to 2 microns (micrometres). The thickness of the liquid layer is uniformed and regularized after the web substrate S and the liquid layer L are pressed against the support surface 10a of the impression cylinder 10 by the pressure roller 12.

FIGS. 4, 5 and 6 are partial side views showing the web substrate S in a nip between the impression cylinder 10 and the printing cylinder 15 of one of the printing units 14. The support surface 10a of the impression cylinder 10 has a maximum impression width MIW comprised between opposite end edges thereof. In this example, the printing cylinder 15 has a printing width PW which in this case is equal than the maximum impression width MIW. However, in other examples the printing width PW can be less than the maximum impression width MIW. The web substrate S has a substrate width SW comprised between side edges thereof which is less than the maximum impression width MIW and less than the printing width PW.

As a result, the support surface 10a of the impression cylinder 10 has one or more covered areas CA which are covered by the web substrate S and two non-covered areas NCA which are not covered by the web substrate S at both sides of the one or more covered areas CA, and the printing cylinder 15 has side end portions extending on the non-covered areas NCA of the support surface 10a of the impression cylinder 10.

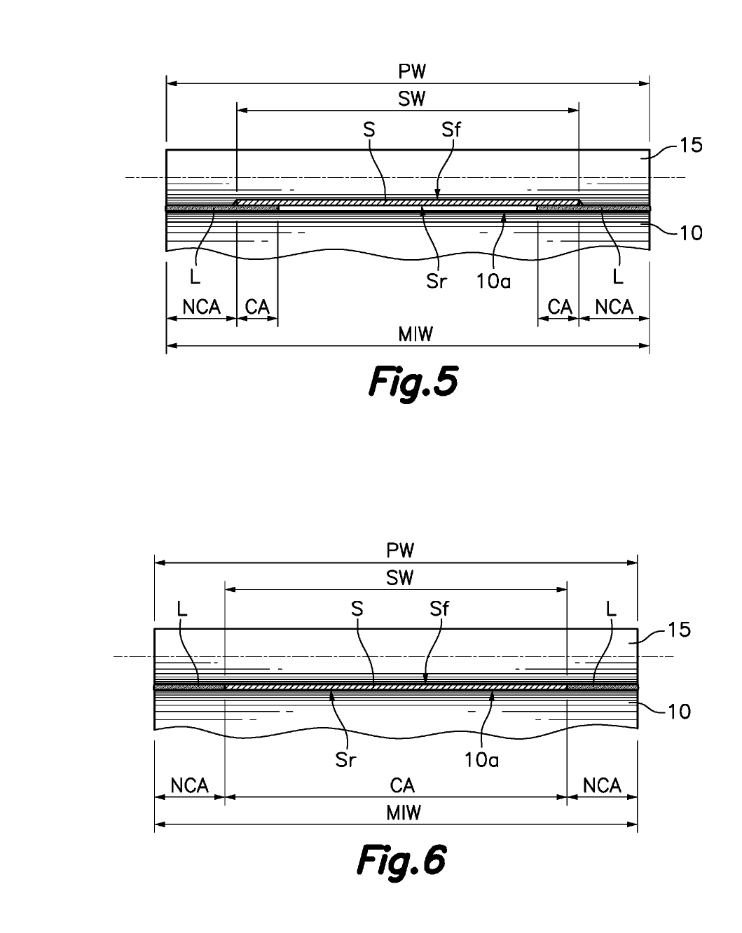

In FIGS. 4, 5 and 6 the thickness of the web substrate S and the thickness of the liquid layer L have been exaggerated for the sake of clarity in the drawing. In FIGS. 4 and 5 the surface of the printing cylinder 15, which is for example an offset printing cylinder provided with a compressible blanket coating, is shown deformed to a certain extent to accommodate the thickness of the web substrate S, and such deformation is also exaggerated for the sake of clarity in the drawing. By virtue of the mentioned deformation of the printing cylinder 15, or otherwise when the thickness of the web substrate S is very thin, the side portions of the printing cylinder 15 are in contact with the non-covered areas NCA of the support surface 10a of the impression cylinder 10 and therefore the ink applied by the printing cylinder 15 could dirt and build-up on these non-covered areas NCA of the support surface 10a of the impression cylinder 10 during printing.

As shown in FIG. 3, the receiving roller 21 and the laminating roller 22 of the liquid applying unit 18 of the printing machine 50 shown in FIGS. 1 and 2 have the same width as the maximum impression width MIW so that the liquid applying unit 18 is able to apply the liquid forming the liquid layer L on the whole support surface 10a of the impression cylinder 10. However, by controlling the aforementioned valve devices 23 with said means for controlling the liquid applying unit 18, the liquid applying unit 18 is able to apply the liquid layer L on one or more specific areas of the support surface 10a of the impression cylinder 10.

FIG. 4 shows an embodiment of the method of the present invention wherein the liquid layer L is applied on the whole maximum impression width MIW of the impression cylinder 10. In other words, the liquid layer L is applied on both the covered areas CA of the support surface 10a of the impression cylinder 10 covered by the web substrate S and a non-covered area NCA of the support surface 10a of the impression cylinder 10 not covered by the web substrate S. The non-covered areas NCA are adjacent two opposite side edges of the web substrate S and the covered area CA spans the complete substrate width SW between the two opposite side edges of the web substrate S.

In the embodiment shown in FIG. 4, the liquid layer L provides during printing an ink-repellent coating on the non-covered areas NCA of the support surface 10a of the impression cylinder 10 which prevents the inks which are being printed by the printing cylinders 15 of the printing units 14 from dirtying and/o building-up on these non-covered areas NCA, making it unnecessary to clean these non-covered areas NCA after a printing work, and an increased bonding of the web substrate S to the support surface 10a of the impression cylinder 10 at the covered areas CA.

FIG. 5 shows another embodiment of the method of the present invention which only differs from the embodiment shown in FIG. 4 in that the liquid layer L is applied on two covered area CA of the support surface 10a of the impression cylinder 10 adjacent the two opposite side edges of the web substrate S in addition to the two non-covered areas NCA of the support surface 10a of the impression cylinder 10 adjacent the two opposite side edges of the web substrate S. Here, the liquid layer L on the two covered areas CA assures an increased bonding of regions of the web substrate S adjacent the two opposite side edges thereof to the support surface 10a of the impression cylinder 10 during printing, and the liquid layer L on the two non-covered areas NCA provides the ink-repellent coating during printing.

FIG. 6 shows still another embodiment of the method of the present invention wherein the liquid layer L is only applied on the two non-covered areas NCA of the support surface 10a of the impression cylinder 10 adjacent the two side edges of the web substrate S, so that during printing the liquid layer L provides an ink-repellent coating on the areas of the support surface 10a of the impression cylinder 10 which are not covered by the web substrate S.

In FIGS. 4, 5 and 6, it is not necessary that the liquid layer covers all the areas of the support surface 10a of the impression cylinder 10 comprised between each side edge of the web substrate S and a corresponding end edge of the impression cylinder 10 or of the printing cylinder 15.

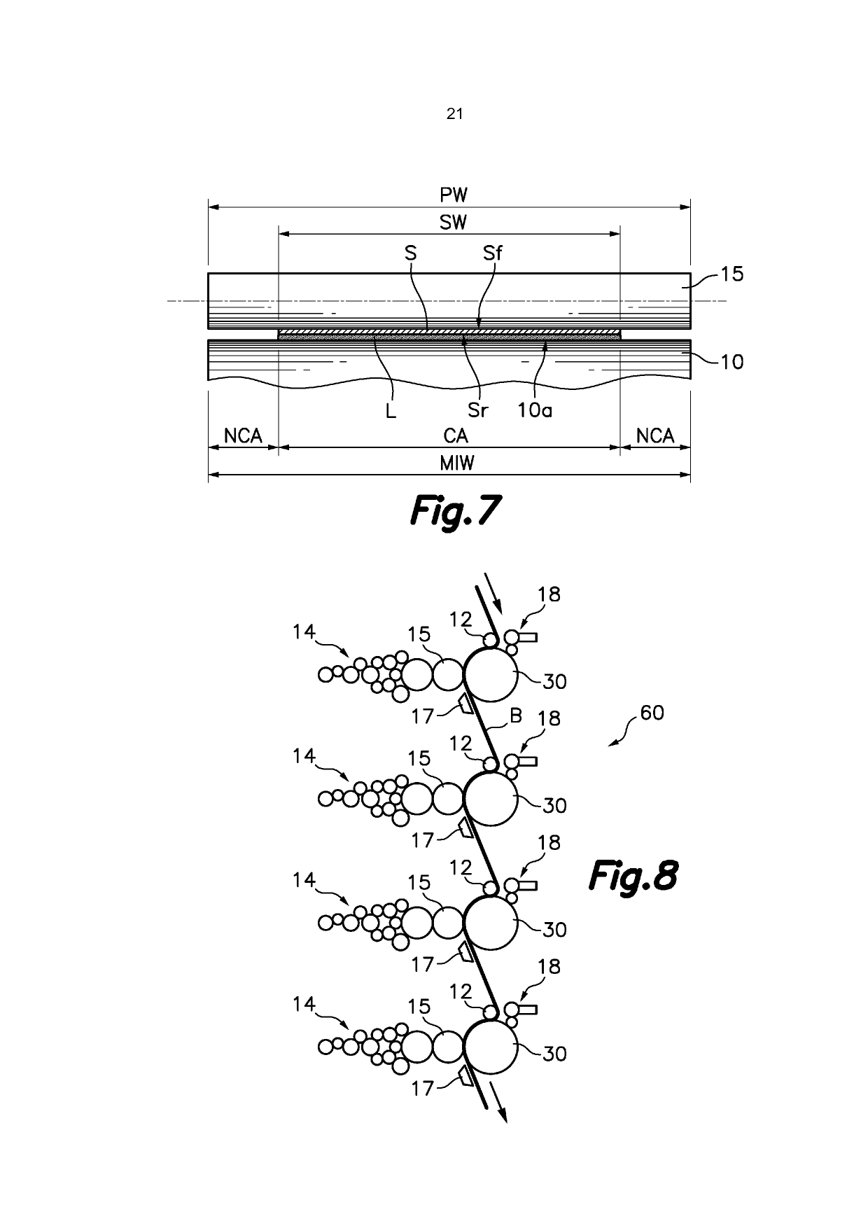

FIG. 7 shows another embodiment which does not belong to the method of the present invention but which can be carried out with the printing machine of the present invention. In the embodiment shown in FIG. 7, the liquid layer L is only applied on the whole covered area CA of the support surface 10a of the impression cylinder 10 which is covered by the web substrate S, so that during printing the liquid layer L provides an increased bonding of the web substrate S to the support surface 10a of the impression cylinder 10. In other variants (not shown) of this embodiment the liquid layer is applied on two or more selected covered areas of the support surface 10a of the impression cylinder 10 which are covered by the web substrate S during printing.

Referring now to FIG. 8, reference sign 60 designates a printing machine according to another embodiment of the second aspect of the present invention, which comprises a plurality of impression cylinders 30 arranged in series to support the web substrate S. One pressure roller 12 is arranged to press the web substrate S against a support surface of each impression cylinder 30. Each pressure roller 12 provides an entry nip in which the web substrate S comes in contact with the support surface of the corresponding impression cylinder 30, and the web substrate S leaves the support surface of each impression cylinder 30 at a leaving line.

One printing unit 14 is arranged to print one ink on the web substrate S supported on each impression cylinder 30. Preferably, one or more of the printing units 14 are offset printing units, although flexographic printing units and/or rotogravure printing units are also envisaged. A drying/curing device 17 is arranged downstream of each printing unit 14 to dry/cure the ink printed by this printing unit 14 on the front face of the web substrate S. Additionally or alternatively, an end drying/curing device (not shown) is arranged to dry/cure the inks printed by the printing units 14 on the web substrate S all together downstream the leaving line of the last printing unit 14.

One liquid applying unit 18 is arranged for applying a liquid insoluble with the ink being printed to form a liquid layer L on a fully exposed portion of the support surface of each impression cylinder 30 upstream of the corresponding pressure roller 12. Each liquid applying unit 18 is configured and arranged as explained above with reference to FIGS. 1, 2 and 3, so that the liquid layer L can be applied by each liquid applying unit 18 so as to cover non-covered areas NCA of the support surface of the corresponding impression cylinder 30 that will be not covered by the web substrate S during printing, in a manner analogous to that explained above with reference to FIG. 6, or to additionally cover one or more covered areas CA of the support surface of the corresponding impression cylinder 30 that will be covered by the web substrate S during printing, in a manner analogous to that explained above with reference to FIGS. 4 and 5, or to cover only one or more covered areas CA of the support surface of the corresponding impression cylinder 30, in a manner analogous to that explained above with reference to FIG. 7.

Both the printing machine 50 described above in relation with FIGS. 1, 2 and 3 and the printing machine 60 described in relation with FIG. 8 implement the method for improving operating conditions of a printing machine according to the first aspect of the present invention.

The scope of the present invention is defined by the appended claims.

1. A method for improving operating conditions of a printing machine, said printing machine comprising:
a rotary impression cylinder having a support surface which supports a web substrate moved in a transport direction,
at least one pressure roller pressing said web substrate against said support surface of said impression cylinder, said pressure roller providing an entry nip at which the web substrate first comes into contact with the support surface of the impression cylinder, and
at least one offset printing unit having a printing cylinder arranged for printing ink on said web substrate that is supported on the impression cylinder; the method comprising:
printing the ink on said web substrate, which is supported on the impression cylinder;
applying a liquid, which is insoluble with the ink, on the support surface of the impression cylinder upstream of said pressure roller, said liquid forming a liquid layer on at least one non-covered area of the support surface of the impression cylinder;
leaving the at least one non-covered area of the support surface uncovered by the web substrate during the printing, the at least one non-covered area of the support surface of the impression roller being adjacent to a side edge of the web substrate during the printing, said liquid layer providing an ink-repellent coating on said at least one non-covered area.

2. The method according to claim 1, wherein the at least one non-covered area includes two no-covered areas of the support surface of the impression cylinder, the liquid forming the liquid layer on the two non-covered areas of the support surface of the impression cylinder that are left uncovered by the web substrate during the printing and that are adjacent to opposite side edges of the web substrate during the printing, the liquid layer providing an ink-repellent coating on said two non-covered areas.

3. The method according to claim 1, wherein the liquid forms the liquid layer additionally on at least one covered area of the support surface of the impression cylinder that is covered by the web substrate during the printing and that is adjacent to a side edge of the web substrate during the printing, the liquid layer providing an increased bonding of the web substrate to said at least one covered area.

4. The method according to claim 3, wherein the covered area of the support surface of the impression cylinder on which the liquid layer is formed spans a substrate width comprised between two opposite side edges of the web substrate.

5. The method according to claim 1, wherein the liquid forms the liquid layer on an area of the support surface of the impression cylinder spanning a maximum impression width comprised between two opposite end edges of the support surface of the impression cylinder.

6. The method according to claim 1, further comprising:
applying said liquid that is insoluble with the ink to the support surface of the impression cylinder by means of a liquid applying unit which forms the liquid layer.

7. The method according to claim 6, wherein operation of said liquid applying unit is controlled by control means to adapt a flow rate and/or a distribution of the liquid applied by said liquid applying unit at least to particularities of the web substrate and/or to a printing speed at which the web substrate is being printed.

8. The method according to claim 1, wherein the liquid layer has a thickness in the range of 0.05 to 2 microns.

9. The method according to claim 1, wherein the ink is a water-insoluble ink and the liquid used to form the liquid layer is water or a liquid based on water.

10. The method according to claim 1, wherein the support surface of the rotary impression cylinder is a smooth non-absorbent support surface.

11. The method according to claim 10, wherein said smooth non-absorbent support surface is provided by a corrosion resistant metallic material selected from the group consisting of stainless steel, chrome, an alloy comprising nickel and molybdenum.

12. The method according to claim 1, wherein the web substrate is made of a non-absorbent material.

13. A printing machine comprising:
a rotary impression cylinder having a support surface which supports a web substrate moved in a transport direction;
at least one pressure roller pressing said web substrate against said support surface of said impression cylinder, said pressure roller providing an entry nip at which the web substrate first comes into contact with the support surface of the impression cylinder;
at least one offset printing unit having a printing cylinder arranged for printing ink on said web substrate supported on the impression cylinder;
a liquid applying unit that applies a liquid that is insoluble with the ink to the support surface of the impression cylinder upstream of said pressure roller, said liquid forming a liquid layer on at least one non-covered area of the support surface of the impression cylinder that is left uncovered by the web substrate during the printing with the ink and that is adjacent to a side edge of the web substrate during the printing with the ink;
wherein said liquid applying unit comprises a plurality of spray nozzles distributed along an axial direction with respect to the impression cylinder, and valve devices associated with liquid supplying ducts which supply the liquid from a liquid supply to the spray nozzles,
the printing machine further comprising control means which control said valve devices to supply the liquid to selected ones of the spray nozzles or to selected groups of spray nozzles, and/or to supply the liquid at a selected flow rate to each spray nozzle or group of spray nozzles.

14. The printing machine according to claim 13, wherein said liquid applying unit further comprises a set of transfer rollers comprising a receiving roller which receives thereon said liquid sprayed from said spray nozzles and a laminating roller which laminates the liquid as the liquid layer onto the support surface of the impression cylinder.

15. The printing machine according to claim 14, wherein said receiving roller and said laminating roller of the liquid applying unit have the same width, in a direction parallel to their own axes, than a maximum impression width comprised between two opposite end edges of the support surface of the impression cylinder, and the spray nozzles are distributed along the length of the receiving roller so as to apply the liquid on the entire surface thereof.

16. The printing machine according to claim 13, wherein the impression cylinder is a central impression cylinder around which a plurality of printing units are arranged for printing a plurality of inks on the web substrate supported on said central impression cylinder.

17. The printing machine according to claim 13, wherein the impression cylinder is one of a plurality of impression cylinders arranged in series to support the web substrate with at least one printing unit arranged for printing ink on said web substrate supported on each of the plurality of impression cylinders.

18. The printing machine according to claim 13, wherein the support surface of the rotary impression cylinder is a smooth non-absorbent support surface.

19. The printing machine according to claim 18, wherein said smooth non-absorbent support surface is provided by a corrosion resistant metallic material including stainless steel, or chrome, or an alloy comprising nickel and molybdenum.
